(19) United States
(12) Patent Application Publication
(10) Pub. No.: US 2013/0200856 A1
(43) Pub. Date: Aug. 8, 2013

(54) Device and Method for Battery Abnormality Processing

(71) Applicant: Wei Zhang, Shanghai (CN)

(72) Inventor: Wei Zhang, Shanghai (CN)

(73) Assignee: O2MICRO, INC., Santa Clara, CA (US)

(21) Appl. No.: 13/486,786

(22) Filed: Jun. 1, 2012

(30) Foreign Application Priority Data
Feb. 2, 2012 (CN) 201210024311.2

(51) Int. Cl. H02J 7/04

(52) U.S. Cl. 320/150

(57) ABSTRACT

Embodiments in accordance with the present invention provide a battery abnormality processing device for processing abnormalities in a battery pack with multiple battery modules. The battery abnormality processing device includes a detecting unit coupled to the battery modules, a comparison unit coupled to the detecting unit and a processing unit coupled to the comparison unit. The detecting unit detects the temperature at each end of each battery module in the battery pack. The comparison unit determines the abnormalities in the battery pack based on the detected temperatures. The processing unit executes an abnormality handling process if an abnormality is determined.

### RELATED APPLICATION

This application claims priority to Chinese Patent Application No. 201210024311.2, titled “Battery abnormality processing device, battery abnormality processing method, battery system and electric equipment”, filed on Feb. 2, 2012, with the State Intellectual Property Office of the People's Republic of China, the disclosure of which is included in its entirety herein.

### BACKGROUND

Batteries are commonly used as power supplies in electric devices, such as electric vehicles and various kinds of portable electric equipments. However, during the charging process, due to loose battery connection or thermal runaway, the temperature of the batteries increases which may cause battery dehydration or expansion. Such issues reduce the life of a battery, and even lead to incineration of the battery. During the discharging process, loose battery connection can cause the imbalance in the heat dissipation, which also reduces the life of a battery. If the temperature is overly high, the connecting wires will burn which causes the battery to incinerate.

Take the electric vehicle as an example. For 10 million electric vehicles that have been sold, 10 to 100 of them suffer from incineration. The main reason for the electric vehicle incineration is the over-heating of batteries. Thus, the rate of battery incineration is approximately 1:10000 to 1:100000. With the wide use of electric vehicles and portable electric equipments, the battery incineration threatens the people's safety.

FIG. 1 shows a battery pack B in a conventional light electric vehicle (LEV) coupled with an LEV charger and an LEV controller. As shown in FIG. 1, in a conventional LEV, an LEV charger V1 for charging the battery pack B and an LEV controller V2 for controlling the speed of an LEV are coupled in parallel to the battery pack B. The battery pack B includes multiple battery modules B1, B2 . . . Bn coupled in series. The connections between LEV controller V2 and other elements of the LEV are not shown in FIG. 1. The conventional LEV structure in FIG. 1 cannot detect battery abnormality in time, e.g., loose battery connection or thermal runaway. Furthermore, it cannot solve those problems in time. Thus the lifetime of batteries may be reduced. More seriously, it may cause the burning of batteries. The conventional solution to solve such problem is to manually tighten each battery module on the regular basis. However, when the abnormality happens while the LEV is running, the problem cannot be detected and solved timely by manual operation.

### SUMMARY

In one embodiment, the present invention provides a battery abnormality processing device for processing abnormality of a battery pack having multiple battery modules. The battery abnormality processing device includes a detecting unit coupled to the battery modules, a comparison unit coupled to the detecting unit and a processing unit coupled to the comparison unit. The detecting unit detects temperatures at both ends of each battery module in the battery pack. The comparison unit determines the abnormalities in the battery pack based on the detected temperatures. The processing unit executes an abnormality handling process if an abnormality is determined.

In another embodiment, the present invention provides an electric equipment which includes a battery system having a battery pack for supplying power for the electric equipment. The battery pack includes multiple battery modules. The battery system includes a battery abnormality processing device coupled to the battery pack. The battery abnormality processing device determines whether an abnormality has occurred in the battery pack based on temperatures at both ends of each battery module in the battery modules of the battery pack and executes an abnormality handling process if the abnormality is determined in the battery pack.

In yet another embodiment, the present invention provides a method for handling battery abnormalities in a battery pack having multiple battery modules. The method includes detecting temperatures at both ends of each battery module; determining if an abnormality has occurred in the battery pack based on the detected temperatures; and performing an abnormality handling processing if the abnormality has occurred in the battery pack.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a battery pack in a conventional LEV coupled to an LEV charger and an LEV controller.

FIG. 2A show an example of a battery abnormality processing device, in accordance to one embodiment of the present invention.

FIG. 2B shows a battery abnormality processing device in FIG. 2A coupled to a battery pack.

FIG. 3 shows a battery abnormality processing device in FIG. 2A coupled with multiple battery modules in a battery pack.

FIG. 4 shows another example of a battery abnormality processing device, in accordance to another embodiment of the present invention.

FIG. 5 shows a battery abnormality processing device in an LEV, in accordance to yet another embodiment of the present invention.

FIG. 6 shows a battery abnormality processing device in an LEV, in accordance to yet another embodiment of the present invention.

FIG. 7 shows a structure of a battery system, in accordance to one embodiment of the present invention.

FIG. 8 shows a flowchart of a method for battery abnormality processing, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

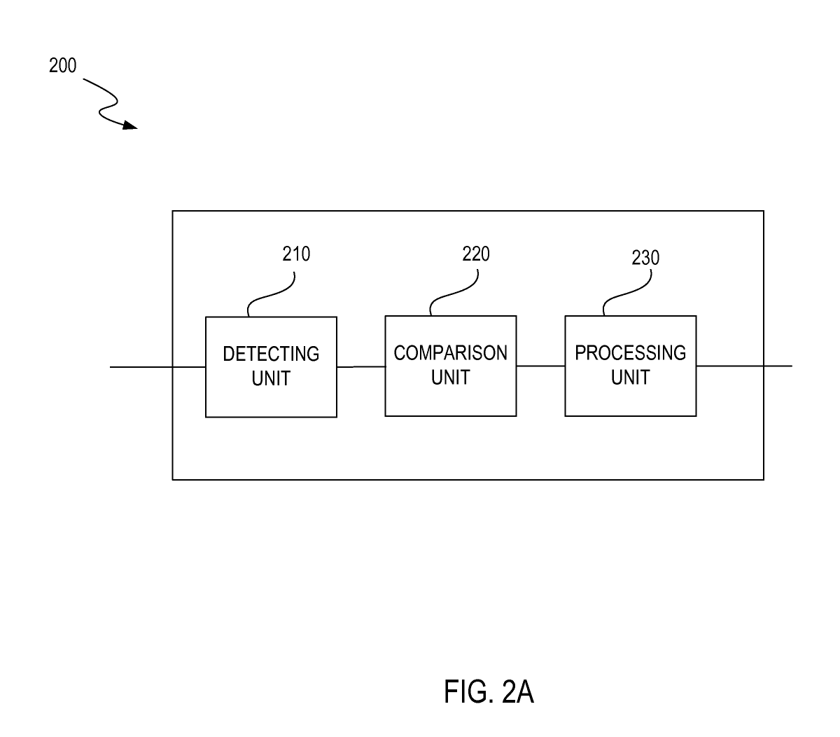

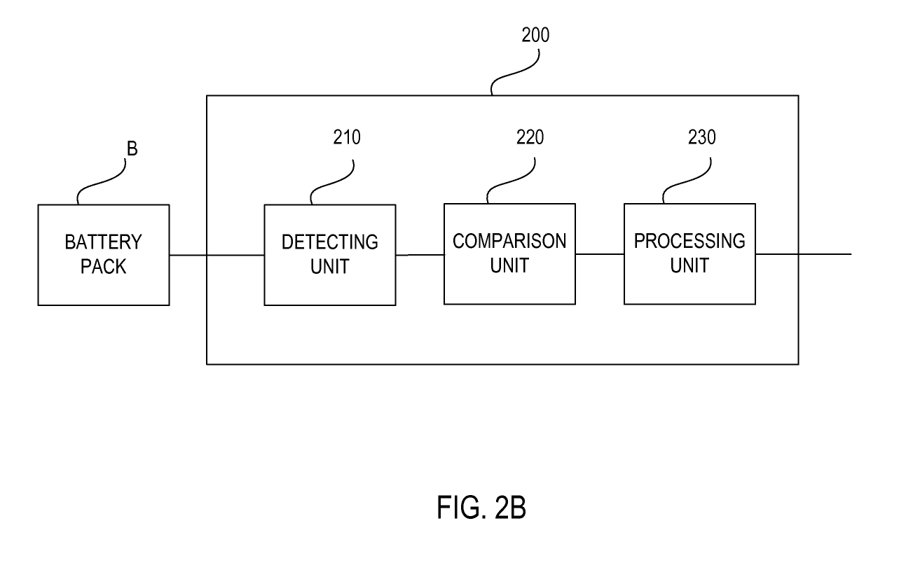

FIG. 2A shows the architecture of a battery abnormality processing device 200, in accordance to one embodiment of the present invention. FIG. 2B shows the battery abnormality processing device 200 in FIG. 2A coupled to a battery pack B. The battery pack B includes multiple battery modules. Each battery module can include one battery cell or multiple battery cells coupled in series or in parallel. Each battery module has two ends that include a positive terminal and a negative terminal.

As shown in the embodiment in FIG. 2A and FIG. 2B, the battery abnormality processing device 200 includes a detecting unit 210, a comparison unit 220, and a processing unit 230. The detecting unit 210 is coupled to a battery pack, e.g., the battery pack B in FIG. 2B, and detects temperatures at both ends of each battery module of the battery pack B. The comparison unit 220 is coupled to the detecting unit 210 and determines whether an abnormality has occurred in the battery pack B based on the temperatures detected by the detecting unit 210. The processing unit 230 is coupled to the comparison unit 220 and performs abnormality handling processing if the comparison unit 220 determines an abnormality has occurred in the battery pack B.

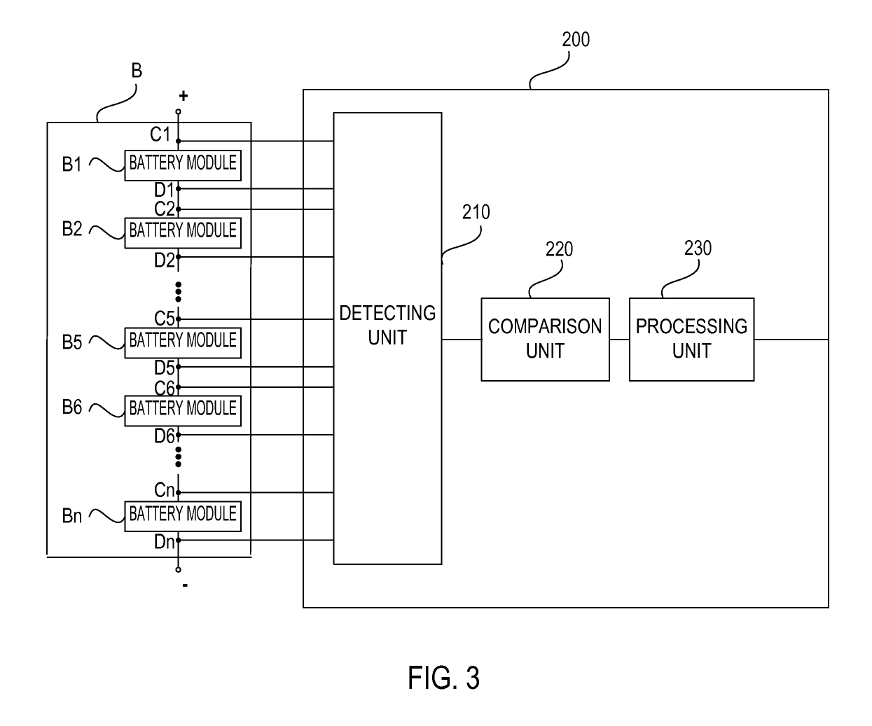

FIG. 3 shows the battery abnormality processing device 200 in FIG. 2A coupled with multiple battery modules in a battery pack B, in accordance with one embodiment of the present invention. As shown in FIG. 3, the battery pack B includes multiple battery modules B1, B2 . . . Bn, and n is an integer greater than or equal to 2. The detecting unit 210 detects the temperatures at both ends of each battery module, for example, the temperatures on the both ends C1 and D1 of battery module B1. The comparison unit 220 determines whether an abnormality has occurred in the battery pack B based on the temperatures detected by the detecting unit 210.

If the temperature difference between the two ends of the battery module is greater than or equal to a first predetermined threshold (which is called the first judgment criterion), the comparison unit 220 can label such battery module as an abnormal battery module which operates abnormally. In other words, the comparison unit 220 determines that an abnormality has occurred in that battery module. For example, if the temperature difference between the end C1 and the end D1, in FIG. 3, is greater than or equal to the first predetermined threshold, e.g., 10 centigrade or another temperature level in the range from 5 to 15 centigrade, the comparison unit 220 labels the battery module B1 as an abnormal battery module which operates abnormally.

Moreover, if a temperature on either end of a battery module is greater than or equal to a second predetermined threshold (which is called the second judgment criterion), the comparison unit 220 can also label such battery module as an abnormal battery module. In other words, the comparison unit 220 determines that an abnormality has occurred in such battery module. For example, as shown in FIG. 3, if the temperature on the end C2 is greater than or equal to the second predetermined threshold, e.g., 80 centigrade, the comparison unit 220 labels the battery module B2 as an abnormal battery module. The comparison unit 220 labels battery modules B2-Bn in the similar way.

Furthermore, if a temperature difference between two adjacent battery modules among the multiple battery modules B1, B2 . . . Bn is greater than or equal to a third predetermined threshold (which is called the third judgment criterion), the comparison unit 220 can label the battery module with a higher temperature of the two adjacent battery modules as an abnormal battery module. In the example of FIG. 3, the “adjacent battery modules” are referred to as two battery modules which have direct electrical connection between them, e.g., the battery module B1 and B2. And the temperature of a battery module can be detected on either end of the battery module. In other words, the temperature difference between the two adjacent battery modules can be detected between any two ends which respectively belong to the two adjacent battery modules. For example, the temperature difference between the battery module B1 and the battery module B2 can be detected between the ends D1 and C2, between the ends D1 and D2, between the ends C1 and C2 or between the ends C1 and D2. In one embodiment, it prefers to detect the temperature difference between two direct adjacent ends, e.g., between the ends D1 and C2. If the temperature difference between the ends D1 and C2 is greater than or equal to the third predetermined threshold, e.g., 10 centigrade or another temperature level in the range from 5 to 15 centigrade, and if the temperature of the end D1 is higher than that of the end C2, the comparison unit 220 can label the battery module B1 as an abnormal battery module. If the battery pack only includes one battery module, the third judgment criterion will not be applied.

The comparison unit 220 can make a judgment based on any judgment criterion among the above three criteria. The comparison unit 220 can also make a judgment based on any combination of the above three judgment criteria.

In one embodiment, the comparison unit 220 makes a judgment based on the first judgment criterion. In other words, the comparison unit 220 checks the temperature difference between two ends of each battery module respectively (e.g., as shown in FIG. 2, between the ends C1 and D1, or between the ends C2 and D2, etc.) to determine whether the temperature difference is greater than or equal to the first predetermined threshold, e.g., 10 centigrade, and determines the battery module as an abnormal battery module if the temperature difference between its two ends is greater than or equal to the first predetermined threshold. For example, if the temperature difference between the end C1 and the end D1 is 15 centigrade, and the temperature difference between the end Cn and the end Dn is 20 centigrade, while the temperature differences between two ends of the rest battery modules are all less than 10 centigrade, the comparison unit 220 labels the battery module B1 and Bn as abnormal battery modules. It is understood that the judging process, which is based on the second or the third judgment criterion, is similar to the above described process and will not be repetitively described herein.

In another embodiment, the comparison unit 220 makes a judgment based on the above three judgment criteria. In other words, for each battery module in the battery pack B, the comparison unit 220 determines whether one battery module is abnormal based on the first and the second judgment criteria. For every two adjacent battery modules, the comparison unit 220 determines whether one battery module of such two adjacent battery modules is abnormal based on the third judgment criterion. Assume that the first predetermined threshold is 10 centigrade, the second predetermined threshold is 80 centigrade, and the third predetermined threshold is 10 centigrade. In such an example, the comparison unit 220 determines the following situations are abnormal: the temperature difference between the ends C1 and D1 is 15 centigrade, the temperature of the ends D2 is 85 centigrade, or the temperature difference between the ends D5 and C6 is 30 centigrade while the temperature of the end C6 is higher than that of the end D5. Consequently, the comparison unit 220 labels the battery module B1, B2 and B6 as abnormal battery modules.

Additionally, it is understood that judging process based on any two of judgment criteria is similar to the above described process and will not be repetitively described herein.

Moreover, it is understood that the above three judgment criteria are for illustrative purpose, and not limitation. The battery abnormality can also be determined based on other criteria. Accordingly, the process executed by the comparison unit 220 is not limited to the above three judgment criteria.

Consequently, the judgment unit 220 can determine whether an abnormality has occurred in the battery pack B based on the temperatures detected by the detecting unit 210. If the battery pack B includes multiple battery modules, the comparison unit 220 can determine which battery module within the battery pack B is abnormal. Then the processing unit 230 can performed the process described below.

If the abnormal battery module (or the abnormal battery pack) is in a charging process, the processing unit 230 can stop the charging of the abnormal battery module (or the abnormal battery pack), which is called a charging cut-off process in the following passages.

If the abnormal battery module (or abnormal battery pack) is in a discharging process, the processing unit 230 can stop the discharging of the abnormal battery module (or the abnormal battery pack), which is called a discharging cut-off process in the following passages.

Advantageously, during the charging/discharging process of a battery pack, if an abnormality has occurred, e.g., loose battery connection or thermal runaway occurs, such abnormality can be detected at an early stage, soon after the temperature of the abnormal battery module or abnormal battery pack begins to rise. Moreover, the present invention can prevent such abnormality from deteriorating by the processing unit 230 executing the charging/discharging cut-off process. As consequence, the temperature of the abnormal battery module or abnormal battery pack can be prevented from continuous increase. Therefore, the present invention extends the life of batteries and reduces the possibility of battery incineration or explosion.

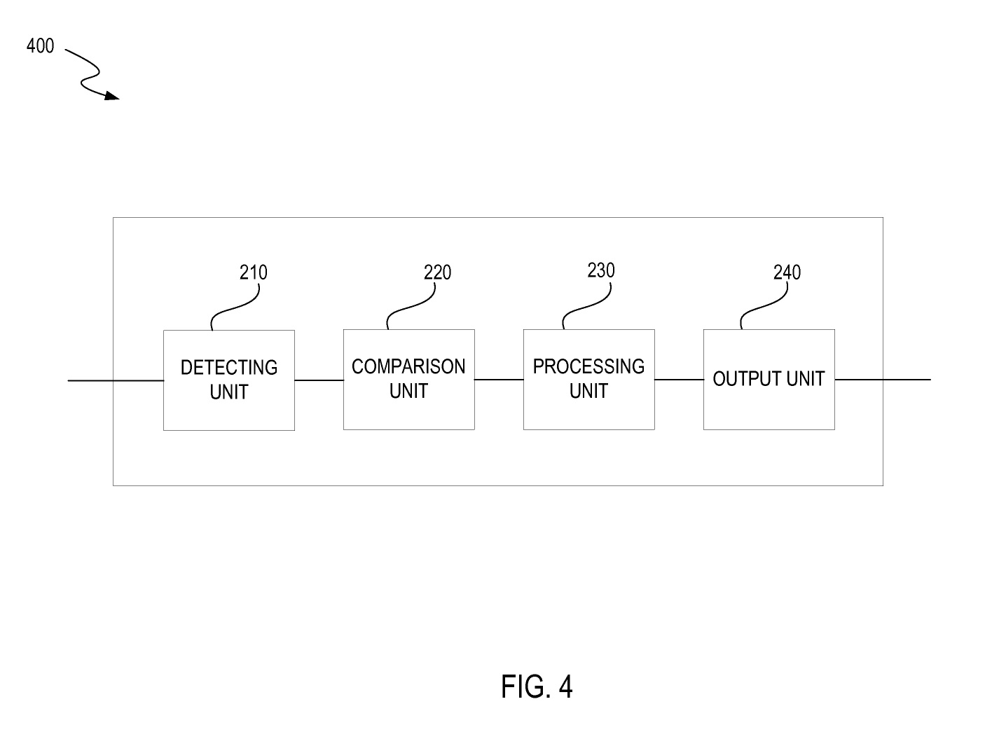

FIG. 4 shows another example of a battery abnormality processing device 400, in accordance with one embodiment of the present invention. In the example of FIG. 4, a battery abnormality processing device 400 includes a detecting unit 210, a comparison unit 220, a processing unit 230 and an output unit 240. Elements labeled as the same in the FIG. 2A have similar function and structure.

In the battery abnormality processing device 400 in FIG. 4, if the comparison unit 220 determines an abnormality has occurred in a battery pack, the processing unit 230 can generate a warning signal. Then the output unit 240 outputs the warning signal to indicate that the battery pack is abnormal.

In one embodiment, the warning signal can be an audio signal. The output unit 240 includes an audio device which can generate the audio signal as a warning signal.

The warning signal can be a visual signal such as an optical signal, an image signal or a text signal, etc. The output unit 240 can include a lighting device (e.g., a light-emitting diode or a small bulb) for generating an optical signal as a warning signal, or/and include a display device (e.g., display) for displaying an image or a text information.

Moreover, the warning signal can be any combination of above described signals (e.g., the audio signal, the optical signal, the image signal and the text signal). Accordingly, the output unit 240 includes devices that are combination of the audio device, the lighting device and the display device.

For example, let's assume that the warning signal includes a combination of a sound signal and a text signal, the output unit 240 in FIG. 4 includes a audio device (not shown) and a display device (not shown). The battery pack B (shown in FIG. 2) includes multiple battery modules B1-Bn. If the comparison unit 220 determines an abnormality has occurred in the battery module B2 of the battery pack B, the audio device in the output unit 240 (shown in FIG. 4) generates an alarm sound, and the display device in the output unit 240 displays the text information which indicates that an abnormality has occurred in the battery module B2. As the result, if a user hears the alarm sound, he/she will know that an abnormality has occurred in the battery pack B of the electrical device. Furthermore, the user will be able to know which battery module of the battery pack B, e.g., the battery module B2, is abnormal from the textual information. Therefore, actions may be performed to correct the abnormality, such as cutting off the connection between the battery pack B and other components, manually tightening the connector of battery module B2 or reinstalling the battery module B2.

Moreover, if the battery pack B is installed inside an electric vehicle and provides power to the electric vehicle, if the comparison unit 220 determines an abnormality has occurred in the battery pack B, the processing unit 230 can control a speed control module located inside the electric vehicle to make the electric vehicle slow down or stop. The speed control module can be a motor controller for the electric vehicle. By controlling the rotating speed of the motor of the electric vehicle through the motor controller, the processing unit 230 can control the speed of the electric vehicle and make it slow down or stop.

When the electric vehicle is being driven, the battery pack B in the electric vehicle is in the discharging process. Once an abnormality (e.g., loose battery connection or thermal runaway) occurs in the battery pack B, the temperature of the battery pack will become abnormal. In this case, the processing unit 230 can control the above described speed control module to make the electric vehicle to slow down or stop. As a result, the discharging of the battery pack B is stopped, the life of the battery is preserved and the possibility of incineration of the battery pack is reduced.

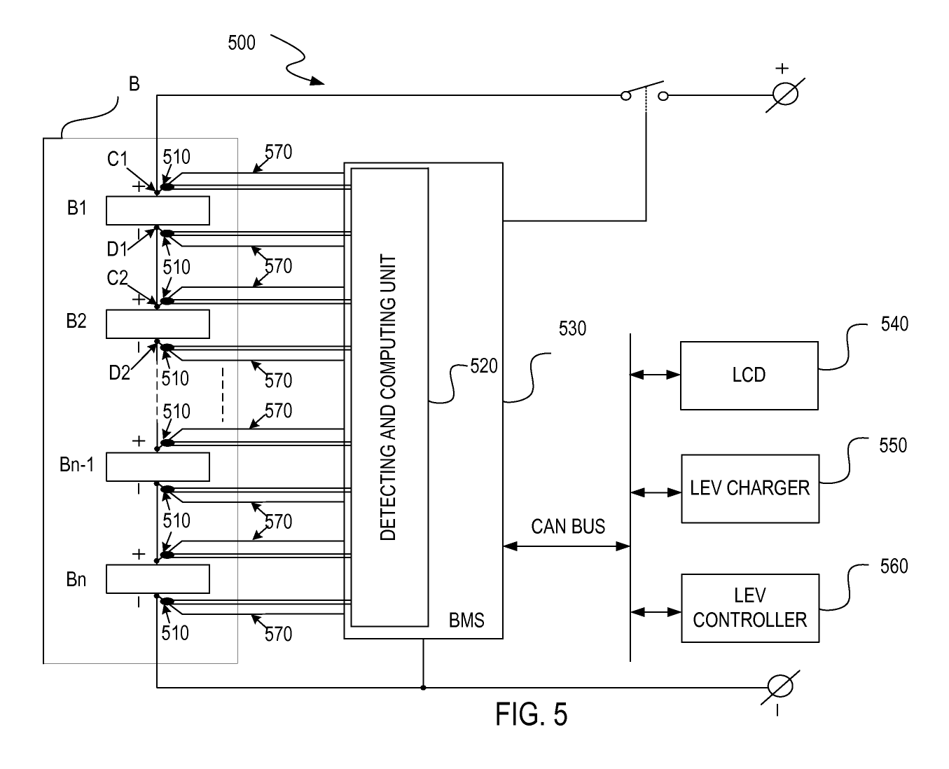

FIG. 5 shows an application diagram of a battery abnormality processing device 500, in accordance with one embodiment of the present invention. More specifically, FIG. 5 shows an application of the battery abnormality processing device 500 in a light electric vehicle (LEV) for processing abnormality of a battery pack B inside the LEV.

In the example of FIG. 5, the battery abnormality processing device 500 includes multiple thermal resistors 510, a detecting and computing unit 520, a battery management system (BMS) 530 and a liquid crystal display (LCD) 540.

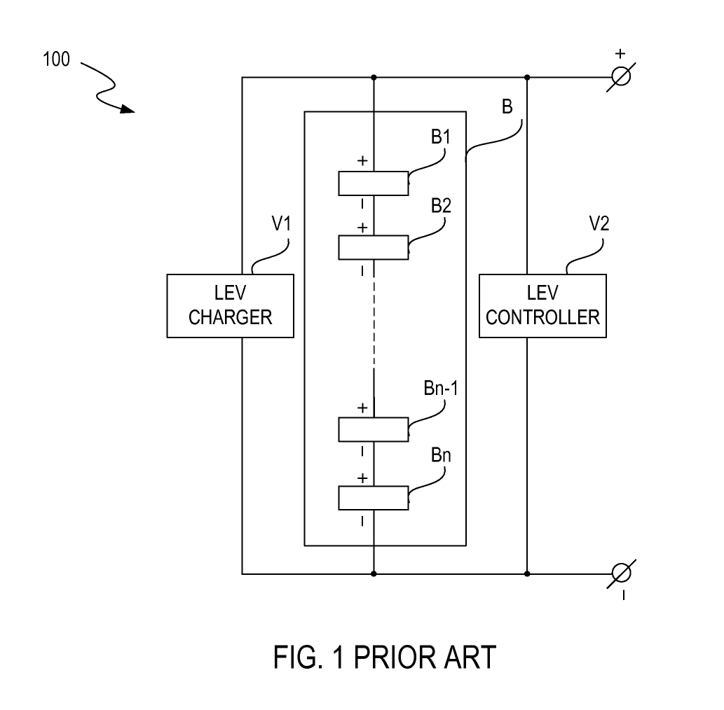

Furthermore, as shown in FIG. 5, the LEV further includes an LEV charger 550 and an LEV controller 560 which are both coupled to the BMS 530 via a controller area network (CAN) bus. For clarity, the connections among the LEV charger 550, the LEV controller 560 and other elements are not shown in FIG. 5. The LEV charger 550 and the LEV controller 560 have similar function as the LEV charger V1 and LEV controller V2 in FIG. 1 and will not be repetitively described herein.

In the battery abnormality processing device 500, the combination of the thermal resistors 510 and the detecting and computing unit 520 performs functions similar to those done by the detecting unit 210 in FIG. 2A-FIG. 4. The detecting and computing unit 520 can be located inside the BMS 530 or outside the BMS 530. In the example of FIG. 5, multiple voltage detecting lines 570 are coupled to the both ends of each battery module for detecting the voltage of each battery module and for providing the detected voltage of each battery module to the BMS 530. The thermal resistors 510 are connected to the voltage detecting lines 570 near battery modules. For example, as shown in FIG. 5, two voltage detecting lines 570 are coupled to an electrode on the end C1 of the battery module B1. One of the thermal resistors 510 is attached to the electrode on the end C1 by thermal conductors, e.g., washer or thermal conducting glue, and the two ends of the thermal resistor 510 are connected to the two voltage detecting lines 570. For example, the heat of the end C1 of the battery module B1 can be transmitted to the thermal resistor 510 through thermal conductors to cause a change of the thermal resistor's temperature. The resistances of the thermal resistors 510 vary with the temperatures of the thermal resistors 510 according to a known pattern. The detecting and computing unit 520 can calculate the resistances of the thermal resistors based on the detected voltages of each battery module. The temperatures of the thermal resistors 510 can be obtained by looking up resistance-temperature reference tables of the thermal resistors 510 usually provided by their manufacturer. Based on the obtained temperatures on both ends of each battery module, BMS 530 can determine whether an abnormality has occurred in a battery pack based on above described judgment criteria.

Besides of the temperature detection, the present invention further employs a voltage detection for determining whether an abnormality has occurred in a battery pack. Based on the voltage on both ends of each battery module, the BMS 530 can determine whether an abnormality has occurred in a battery module based on detected voltage on either end of the battery module. The BMS 520 can determine that an abnormality has occurred in the battery pack if a difference between a voltage change rate of a first battery module and a voltage change rate of a second battery module is greater than a predetermined threshold. For example, assume that the voltage of the first battery module increased 420 mv during 1 second, the voltage of the first battery module increased 200 mv during 1 second, and the predetermined threshold is 200 mv/s. Because the difference between the two voltage change rates is 220 mv/s which is greater than 200 mv/s, the BMS 530 determines that abnormality has occurred. If an abnormality is determined an abnormality handling process for that abnormality can be performed by the BMS 530. The voltage detection by the voltage detecting lines 570 is optional for an LEV.

In the example of FIG. 5, in the battery abnormality processing device 500, the BMS 530 is equivalent to a combination of the comparison unit 220 and the processing unit 230 in FIG. 2A-FIG. 4. That is, the BMS 530 performs the functions of the comparison unit 220 and the processing unit 230. Furthermore, the LCD 540 functions as the output unit 240 in FIG. 4.

More specifically, the detecting and computing unit 520 is coupled to both ends of each thermal resistor 510 through two wires. The detecting and computing unit 520 calculates the resistances of each thermal resistor 510 based on the voltage on both ends of each battery module, and then obtain a temperature of each thermal resistor 510 by looking up the temperature-resistance reference tables of thermal resistors 510 provided by their manufacturer. The temperature of the thermal resistor 510 can be taken as the temperature of an end of the battery module which is near the thermal resistor 510.

As described above, the temperatures of both ends of each battery module among the multiple battery modules B1-Bn can be obtained by detecting voltage on both ends of each battery module, calculating the resistance of each thermal resistor 510 and looking up a temperature-resistance reference table which indicates a relation between resistance and temperature of each thermal resistor 510. The BMS 530 can determine whether an abnormality has occurred based on the above described three judgment criteria. If an abnormality is determined, an abnormality handling processing for that abnormality can be performed by the BMS 530.

Moreover, when an abnormality is determined, the LCD, which is coupled to the BMS via a CAN bus can display relevant information about the abnormal battery modules. The LCD 540 is also optional equipment for an LEV.

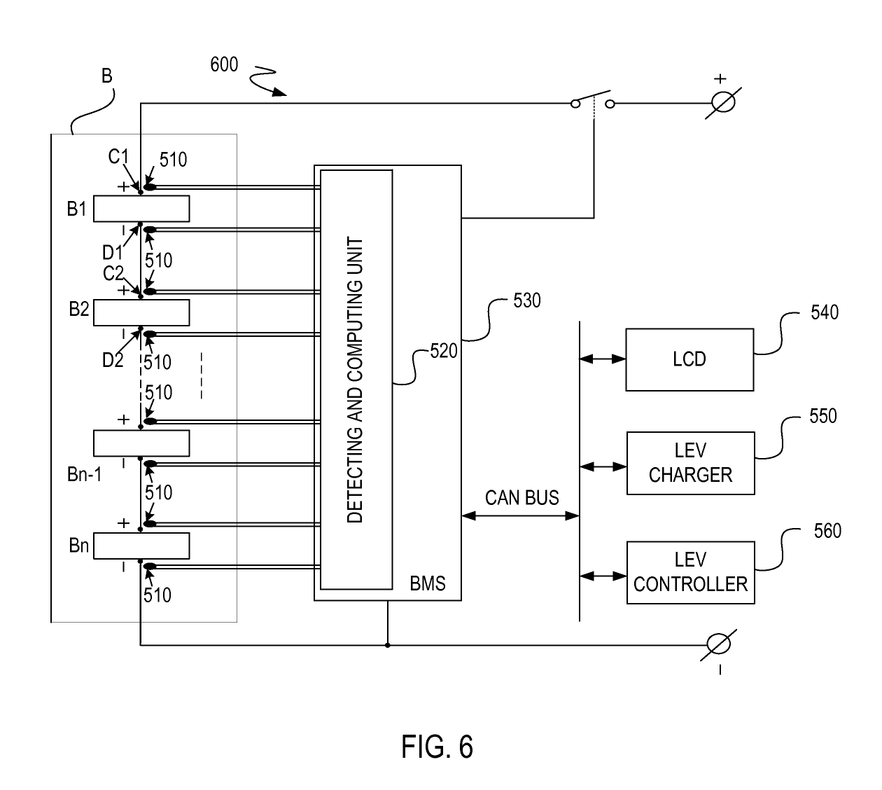

FIG. 6 illustrates an alternative architecture of a battery abnormality processing device 600, in accordance with another embodiment of the present invention. More specifically, FIG. 6 shows an application of the battery abnormality processing device 600 in a light electric vehicle (LEV) for processing abnormality of a battery pack B inside a LEV. Different from the example shown in FIG. 5, the battery abnormality processing device 600 does not include the voltage detecting lines. In the embodiment of FIG. 6, the thermal resistors 510 are coupled to the electrodes of the battery modules and receive the heat from the electrode. In one embodiment, each of the thermal resistors 510 can be directly or indirectly coupled to an electrode of a battery module. For example, a metal washer (not shown in FIG. 6) can be placed on the electrode of the battery module and the thermal resistors 510 can be attached on the metal washer by connection fixing element (e.g., a metal clip). Thus the thermal resistors 510 can have indirect contact with the electrode through the metal washer and receive the heat transmitted through the electrode. The thermal resistors 510 can also be attached on the electrodes of battery modules using thermal-conducting glue. The heat of the electrodes can also be transmitted to the thermal resistors 510, which makes the thermal resistors 510 have similar temperature as those of corresponding electrodes. In another embodiment, the thermal resistors 510 have no contact with the electrodes. As shown in FIG. 6, the thermal resistors 510 can be placed near the electrodes of the battery modules in various ways with a sufficiently small space between the thermal resistors 510 and the electrodes such that the thermal resistors 510 can receive from air the heat dissipated by the electrodes. The present invention intends to cover any other methods for placing the thermal resistors 510 to detect the electrode temperature which can be recognized by one of ordinary skill in the art.

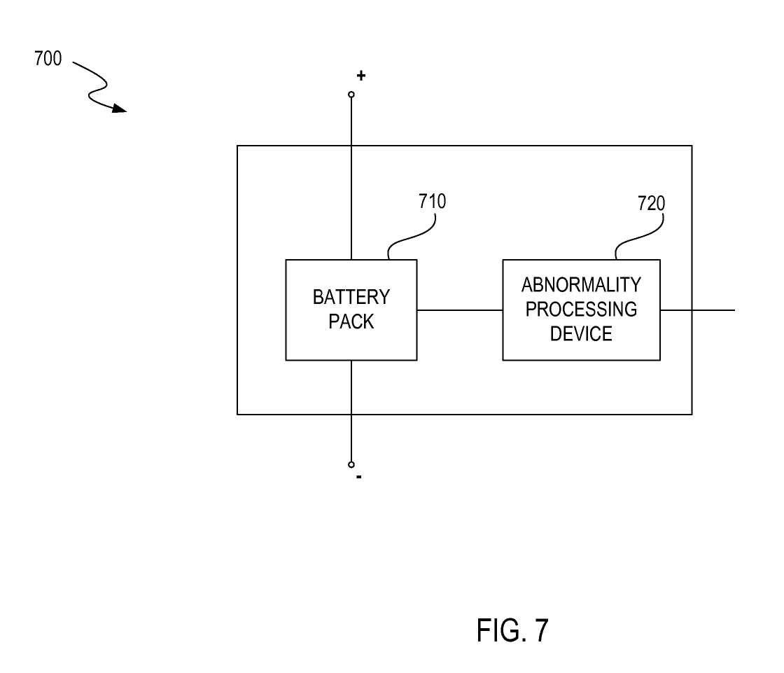

FIG. 7 shows a structure of a battery system 700, in accordance with one embodiment of the present invention. In the example of FIG. 7, the battery system 700 includes a battery pack 710 and a battery abnormality processing device 720. The battery abnormality processing device 720 can be any one of the battery abnormality processing device shown previously in FIG. 2A-FIG. 6. The battery system 700 according to the present invention can prevent problems (e.g., battery dehydration, battery expansion or battery incineration) caused by battery abnormalities, such as loose battery connection or thermal runaway. Therefore, the lifetime of the battery pack 710 can be extended and the possibility of battery incineration is reduced.

In addition, embodiments in accordance with the present invention further include an electric equipment. The electric equipment includes above described battery system 700. The electric equipment uses the above described battery system 700 as a power source for supplying power for other elements of the electric equipment. For example, the electric equipment can be an electric vehicle or a portable electric equipment. Because the battery system 700 in the electric equipment can prevent problems (e.g., battery dehydration, battery expansion or battery incineration) caused by battery abnormalities such as loose battery connection or thermal runaway, the lifetime of the battery system can be extended and the possibility of battery incineration can be reduced. As such, the lifetime of the electric equipment can be extended and the potential safety hazard caused by the battery abnormality can be reduced.

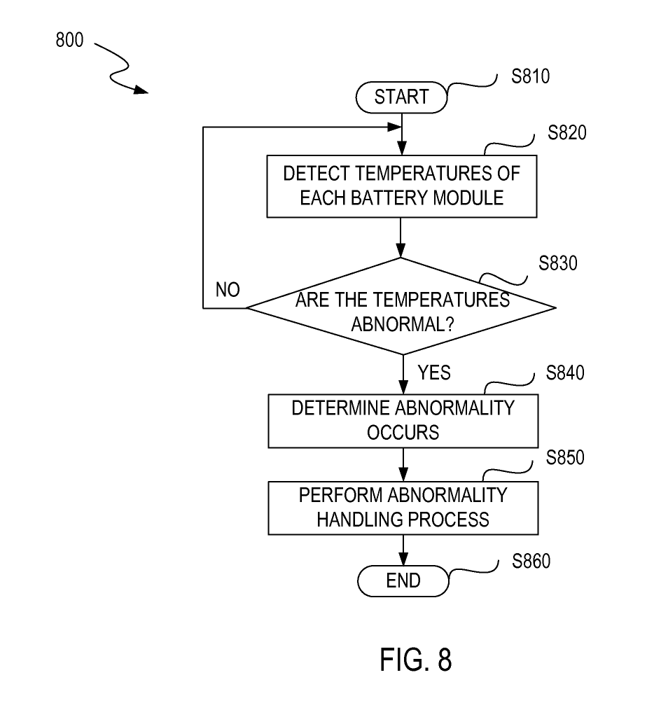

FIG. 8 shows a flowchart 800 of a method for battery abnormality processing, in accordance with one embodiment of the present invention. FIG. 8 is described in combination with FIG. 4. As shown in FIG. 8, the abnormality processing flowchart 800 begins at the step S810 and goes to step S820. The detecting unit 210 detects the temperatures at both ends of each battery module in the battery pack B, S820. In one embodiment, the detecting unit 210 detects temperatures of both electrodes of each battery module in the battery pack B. Then the comparison unit 220 checks whether the temperatures are abnormal based on any one or a combination of the above described three criteria, S830. If yes, the comparison unit 220 determines an abnormality has occurred in the battery pack B, S840, and then the flowchart 800 goes to step S850. Otherwise, if the temperatures are determined to be normal, the flowchart returns to the step S820 to keep checking the temperatures at both ends of each battery module in the battery pack B. Once abnormality of temperatures is detected, the flowchart 800 goes to the step S840 and the comparison unit 220 determines that an abnormality has occurred in the battery pack. The comparison unit 220 can further determine which battery module in the battery pack is abnormal, S840. After determining the abnormality, the processing unit 230 performs abnormality handling process, S850, e.g., charging/discharging cut-off process.

In addition, the processing unit 230 can generate a warning signal. The output unit 240 can output the warning signal to indicate that an abnormality has occurred in the battery pack B (such abnormality handling process is not shown in FIG. 8), S850. Furthermore, if the battery pack B is used for powering an electric vehicle equipped with a speed control module, the processing unit 230 can control the speed of the electric vehicle and make it slow down or stop, as part of the abnormality processing, S850.

Accordingly, embodiments in accordance with the present invention provide battery abnormality processing devices and a method for battery abnormality processing that can detect the temperatures at both ends of each battery module in a battery pack, and can determine whether an abnormality (e.g., loose battery connection or thermal runaway) has occurred in the battery pack based on the detected temperatures. Moreover, if an abnormality occurs, corresponding abnormality handling process can be performed timely.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A battery abnormality processing device, for processing abnormalities in a battery pack, the battery pack having a plurality of battery modules, each battery module having two ends, comprising:
a detecting unit, coupled to the battery modules, for detecting temperatures at each end of each battery module in the battery pack;
a comparison unit, coupled to the detecting unit, for determining the abnormalities in the battery pack based on the detected temperatures; and
a processing unit, coupled to the comparison unit, for executing an abnormality handling process if an abnormality is determined.

2. The battery abnormality processing device of claim 1, wherein the comparison unit is configured to:
label a battery module as an abnormal battery module if a temperature difference between two ends of the battery module is greater than or equal to a first predetermined threshold;
label a battery module as an abnormal battery module if a temperature on either end of the battery module is greater than or equal to a second predetermined threshold; and
label a battery module which has a higher temperature of two adjacent battery modules as an abnormal battery module if a temperature difference between the two adjacent battery modules is greater than or equal to a third predetermined threshold.

3. The battery abnormality processing device of claim 2, wherein if the comparison unit determines an abnormality in the battery pack, the processing unit is configured to:
stop charging the abnormal battery module if the abnormal battery module is in a charging process; and
stop discharging the abnormal battery module if the abnormal battery module is in a discharging process.

4. The battery abnormality processing device of claim 1, wherein if the comparison unit determines an abnormality in the battery pack, the processing unit further generates a warning signal.

5. The battery abnormality processing device of claim 4, further comprising:
an output unit that outputs the warning signal to indicate that the battery pack is abnormal.

6. The battery abnormality processing device of claim 1, if the comparison unit determines an abnormality in the battery pack, the processing unit controls a speed control module in an electric vehicle to slow down or stop the electric vehicle.

7. An electric equipment comprising:
a battery system having a battery pack for supplying power for the electric equipment, wherein said battery pack comprises a plurality of battery modules, and wherein the battery system comprises:
a battery abnormality processing device, coupled to the battery pack, for determining whether an abnormality has occurred in the battery pack based on temperatures at both ends of each battery module in the battery modules of the battery pack and for executing an abnormality handling process if the abnormality is determined in the battery pack.

8. The electric equipment of claim 7, wherein the battery abnormality processing device is configured to:
label a battery module as an abnormal battery module if a temperature difference between two ends of the battery module is greater than or equal to a first predetermined threshold;
label a battery module as an abnormal battery module if a temperature on either end of the battery module is greater than or equal to a second predetermined threshold; and
label a battery module which has a higher temperature of two adjacent battery modules as an abnormal battery module if a temperature difference between the two adjacent battery modules is greater than or equal to a third predetermined threshold.

9. The electric equipment of claim 8, wherein if the battery abnormality processing device determines an abnormality in the battery pack, the battery abnormality processing device is configured to:
stop charging the abnormal battery module if the abnormal battery module is in a charging process; and
stop discharging the abnormal battery module if the abnormal battery module is in a discharging process.

10. A method, for handling battery abnormalities in a battery pack having a plurality of battery modules, comprising:
detecting temperatures at both ends of each battery module;
determining if an abnormality has occurred in the battery pack based on the detected temperatures; and
performing an abnormality handling processing if the abnormality has occurred in the battery pack.

11. The method of claim 10, wherein the step of determining if an abnormality has occurred in the battery pack further comprises:
labeling a battery module as an abnormal battery module if a temperature difference between two ends of the battery module is greater than or equal to a first predetermined threshold;
labeling a battery module as an abnormal battery module if a temperature at either end of the battery module is greater than or equal to a second predetermined threshold; and
labeling a battery module which has a higher temperature of two adjacent battery modules as an abnormal battery module if a temperature difference between the two adjacent battery modules is greater than or equal to a third predetermined threshold.

12. The method of claim 11, wherein the step of performing an abnormality handling processing further comprises:
stop charging the abnormal battery module if the abnormal battery module is in a charging process; and
stop discharging the abnormal battery module if the abnormal battery module is in a discharging process.

13. The method of claim 10, wherein the step of performing an abnormality handling processing further comprises:
generating a warning signal if an abnormality is determined in the battery pack.

14. The method of claim 13, further comprising:
outputting the warning signal to indicate that the battery pack is abnormal.

15. The method of claim 10, wherein the step of performing an abnormality handling processing further comprises:
controlling a speed control module in an electric vehicle to slow down or stop the electric vehicle.
